(19) United States
(12) Patent Application Publication
(10) Pub. No.: US 2021/0114144 A1
(43) Pub. Date: Apr. 22, 2021

(54) MULTLAYER BRAZING SHEET

(71) Applicant: CONSTELLIUM NEUF-BRISACH, Biesheim (FR)

(72) Inventors: Bechir CHEHAB, Voiron (FR); Lionel PEGUET, Quaix en Chartreuse (FR); Florian MONNIER, Grenoble (FR)

(21) Appl. No.: 17/047,430

(22) PCT Filed: Apr. 11, 2019
(86) PCT No.: PCT/EP2019/059325

§ 371 Date: Oct. 14, 2020

(30) Foreign Application Priority Data
Apr. 16, 2018 (FR) 1853307

(51) Int. Cl. B23K 35/02; B23K 35/28

(52) U.S. Cl. CPC B23K 35/0238; B32B 15/016; B23K 35/288

(57) ABSTRACT

The present invention deals with a brazing sheet comprising:
a core layer made of a AA3xxx alloy comprising, in weight percentages: up to 0.70% Si, up to 0.70% Fe, 0.20 to 1.10% Cu, 0.70 to 1.80% Mn, up to 0.40% Mg, up to 0.30% Zn, up to 0.30% Ti, Zr and/or Cr and/or V each up to 0.30%, other elements less than 0.05% each and less than 0.15% in total, balance being aluminium;
a brazing layer, made of a AA4xxx alloy which is present on at least one side of the core layer; and
an interlayer, inserted between the core layer and the brazing layer, on at least one side of the core layer, which composition comprises, in weight percentages: from 1.5 to 2.3% Zn, from 0.2 to 0.75% Mn, up to 0.5% Fe, up to 0.5% Si, other elements less than 0.05% each and less than 0.15% in total, balance being aluminium.

### FIELD OF THE INVENTION

The present invention deals with an aluminium brazing sheet to be used in heat exchanger systems, such as for instance heat exchangers for automotive purposes. Ideally the brazing sheet is used for manufacturing tubes or plates of such a heat exchanger. Heat exchangers may for example be charge air coolers (CAC), exhaust gas recirculation (EGR) coolers, evaporators, condensers or radiators.

In particular, the present invention deals with new brazing sheets solutions for Charge Air Cooler (CAC) application (see FIGS. 1 and 2). In service, CAC heat exchangers, when cooling down, are exposed to aggressive acid condensate from a mix of compressed exhaust gas and air, which requires aluminium brazing sheets with increased corrosion resistance.

### BACKGROUND OF THE INVENTION

Heat exchangers for the automotive industry are nowadays mainly made of aluminium alloys because of their low density, which allows weight saving, in particular compared to copper alloys, while ensuring good heat conduction, ease of use and good resistance to corrosion.

As will be appreciated in the following description, alloy and temper designations, except otherwise indicated, refer to the Aluminum Association designations in Aluminum Standards and Data and the Registration Records, all published by the US Aluminum Association.

Heat exchangers generally comprise tubes or pairs of plates, stacked one above the other, for the circulation of the internal fluid, fins to increase the heat transfer between the internal fluid and the external fluid and optional turbulator inside the tubes or pairs of plates for the same goal as fins. For CAC application, the internal fluid may be the gas to be cooled or a refrigerant, depending on the configuration. It flows through the tubes or through the channel formed by the pairs of plates. The external fluid may be air or the gas to be cooled, depending on the configuration. It flows between the tubes or the pairs of plates and through the optional fins.

For radiator application, the internal fluid is the fluid to be cooled and the external fluid is air.

For evaporator application, the internal fluid is a refrigerant and the external fluid is the air to be cooled for air conditioning.

The manufacture of heat exchangers is done either by mechanical assembly or by brazing. The first step of the manufacturing process is to produce a sheet, which is then used to obtain a tube or a plate. A tube is generally obtained by sheet roll forming and welding or brazing. A plate is generally obtained by stamping a sheet. Two plates are paired so as to form a channel through which a fluid could flow.

The usual brazing sheet configuration is as follows: a core layer, generally made of aluminium alloy of the AA3xxx series, is cladded on one or both sides with a so-called brazing layer, generally of the AA4xxx series. The brazing layer has the advantage to melt at a temperature lower than the melting temperature of the core layer, so that, by applying a thermal brazing cycle, it is possible to create a bond between two materials to be assembled.

The 3-layers configuration is illustrated in FIG. 3, where the core layer has the reference number 2 and the brazing layers have the reference number 1. The brazing layers may have the same or a different composition. The fins, which are positioned between the different rows of tubes or pairs of plates (i.e. on the external side of tubes or pairs of plates), consist of a AA3xxx series alloy that could be cladded or not. The brazing of the fins on the tubes or pairs of plates is ensured by the brazing layer made of an AA4xxx series positioned on the external side of the tube or pair of plates. The alloy of the AA3xxx series used for the core layer of the tube or plate is most often made of a so-called “long-life” alloy, that is to say with good resistance to external saline corrosion.

However common three layers brazing sheets solutions are generally not suitable for CAC type heat exchangers due to rapid corrosion penetration into the core layer of the sheets.

In general, in order to improve the corrosion resistance of the brazing sheets, a solution consists in inserting an interlayer made of an alloy of AA1xxx or AA7xxx series between the core layer of the tubes or plates and the brazing layer made of a AA4xxx series.

Such a configuration is schematically represented in FIG. 4, where the core layer of the tubes or plates has the reference number 2, the brazing layers made of an alloy of the AA4xxx series (which could have similar or different compositions) has the reference number 1 and the interlayer, generally made of an alloy of the AA1xxx or AA7xxx series, has the reference number 3.

Such an interlayer improves corrosion behavior by two mechanisms. Firstly, it limits the diffusion during brazing of elements from the brazing layer to the core layer of the tubes or plates (for example silicon) and also from the core layer to the brazing layer (for example copper). Secondly, either it provides sacrificial anode protection, the corrosion potential of the interlayer being lower than that of the core layer or it is more corrosion resistant than the core layer.

These multilayer sheets are known from the person skilled in the art and are described in particular in the following patent applications: JP2003/027166 A of Kobe Steel Ltd. Shinko Alcoa, JP2005/224851A of Shinko Alcoa Yuso Kizai KK, WO2006/044500A2 and WO2009/142651A2 of Alcoa Inc, WO2007/042206A1 of Corus Aluminium Walzprodukte GmbH, US2010/0159272A1 of Novelis, etc. . . .

The use of this type of multilayer sheet in a charge-air cooler with exhaust gas passage is described in the patent application WO2008/063855 of Modine Mfg Co.

This use is also described in the publication <<New Advanced Materials-New Opportunities for Brazed HX Folded Tubes & Hydro MultiClad Materials>>, Hartmut Janssen, 7th Aluminium Brazing Conference, 2012, and in the following patent applications: WO2009/128766A1 of <<Sapa Heat Transfer AB>>, WO03/089237, EP2065180A1, WO2006/044500A2 of <<Alcoa Inc.>>, WO2007/042206A1 and FR2876606 of <<Corus Aluminium Walzprodukte GmbH>>.

However, although such configurations make it possible to improve the corrosion resistance of the tubes or plates, they may be insufficient under particularly severe corrosion conditions, as is the case for heat exchangers subjected to recirculation of exhaust gases characterized in particular by a low pH.

As a solution, it is known to use a Zn containing interlayer to improve the corrosion resistance of these brazing sheets. Common interlayers are made of for example a AA7072 alloy or a AA3003 alloy with Zn. The Zn containing interlayers act as sacrificial anode, forcing the corrosion to attack the inner surface of the heat exchanger in a lateral way instead of penetrating the core layer by localized pitting or intergranular corrosion.

Another solution is described in particular in the patent EP1934013B1 of Aleris which describes a 4-layer brazing sheet solution with two 4xxx layers, a 3xxx core layer (containing 0.55 to 1% Cu) and a 3xxx interlayer with 0.1 to 5% Zn and 0.5 to 1.5% Mn.

Furthermore, hot rolling of a multilayer sandwich with an interlayer having low flow stress at high temperature is particularly difficult. The choice of the interlayer in this case needs to be made with care, to prevent difficult or even impossible bonding between the interlayer and the surrounding layers.

A solution for facilitating rolling is to increase the high temperature flow stress of the interlayer, in particular by the addition of hardening elements. This is the case for titanium, at levels up to 0.3% as mentioned in the patent application WO2009/128766A1 of “Sapa Heat Transfer AB”. Manganese is also mentioned as a solid solution hardener.

The above patent applications, as well as WO2009/142651A2 of “Alcoa Inc.” claim an AA3xxx alloy interlayer.

### SUMMARY OF THE INVENTION

The main aim of the present invention is to optimize the composition of the multilayer composite material or brazing sheet made of aluminium alloy, and in particular of the core layer and interlayer, in order to improve their behavior in a severe corrosive environment such as that created by the recirculation of exhaust gases from motor vehicles and, to a lesser extent, air-conditioning evaporators, without any surplus of material used, no significant weight and allowing production conditions, from the point of view of the ease of implementation and the cost, at least equivalent to the solutions of the prior art.

Another aim of the present invention is to optimize the sacrificial nature of the interlayer and thus to increase the lateralization of the corrosion at the surface of the sheet and thus to delay as far as possible the penetration of corrosion into the core layer.

The corrosion behavior of brazing sheets may be evaluated through a specific cyclic corrosion test using a synthetic acid condensate called “CAC test”. This test is described in the examples hereinafter.

As said hereinabove, common three layers brazing sheets solutions are generally not suitable for CAC type heat exchangers due to rapid corrosion penetration into the core layer of the sheets. In order to meet CAC corrosion requirement, four layer solutions in which a sacrificial interlayer is added between the 4xxx brazing layer and the core layer have been developed. However, it remains difficult to obtain sheets that are resistant to corrosion and at the same time suitable for hot rolling.

The applicant has developed a multilayer brazing sheet that allows to optimize the sacrificial aspect of the interlayer compared to the core layer via addition of Zn to a Mn-containing interlayer. This newly developed interlayer contains enough Mn to make the sheet hot rolling feasible and has shown improvement in corrosion resistance in the CAC test compared to existing solutions.

An object of the present invention is a brazing sheet comprising, preferably consisting essentially of, more preferably consisting of:
a core layer made of a AA3xxx alloy comprising, in weight percentages: up to 0.70% (preferably 0.10 to 0.30%) Si, up to 0.70% (preferably up to 0.40%, more preferably up to 0.25%) Fe, 0.20 to 1.10% (preferably 0.30 to 1.00%) Cu, 0.70 to 1.80% (preferably 1.10 to 1.60%) Mn, up to 0.40% (preferably up to 0.30%) Mg, up to 0.30% (preferably up to 0.20%) Zn, up to 0.30% (preferably up to 0.20%) Ti, Zr and/or Cr and/or V each up to 0.30%, other elements less than 0.05% each and less than 0.15% in total, balance being aluminium;
a brazing layer, made of a AA4xxx alloy (for example AA4343 or AA4045, preferably comprising 5-13 wt. % Si) which is present on at least one side (preferably on both sides) of the core layer; and
an interlayer, inserted between the core layer and the brazing layer, on at least one side (according to an embodiment on both sides) of the core layer, which composition comprises (preferably consists essentially of, more preferably consists of), in weight percentages: from 1.5 to 2.3% Zn, from 0.2% (preferably 0.3%) to 0.75% (preferably 0.45%) Mn, up to 0.5% (preferably 0.4%) Fe, up to 0.5% (preferably 0.4%) Si, other elements less than 0.05% each and less than 0.15% in total, balance being aluminium.

Another object of the present invention is the use of a brazing sheet according to the present invention for the production of a heat exchanger of a motor vehicle, preferably a charge air cooler (CAC), an exhaust gas recirculation (EGR) cooler, an evaporator, a condenser or a radiator.

Another object of the present invention is the use of a brazing sheet according to the present invention, for the production of a heat exchanger, in which the heat exchanger is a water charge air cooler comprising a tube or a channel formed by a pair of plates, having an external side where the gas to be cooled flows, said tube or plates being made from the brazing sheet according to the present invention with the interlayer located on said external side, and comprising fins made of an aluminium alloy having a Zn content from 1.25 to 3.00 wt. % fixed on said external side, and in which the Zn content of the interlayer is less than 120%, preferably less than 100% of the Zn content of the fins.

Another object of the present invention is a heat exchanger of a motor vehicle, preferably a charge air cooler (CAC), an exhaust gas recirculation (EGR) cooler, an evaporator, a condenser or a radiator, more preferably a charge air cooler, characterized in that it is produced partly from a brazing sheet according to the present invention.

Another object of the present invention is a heat exchanger as described hereinbefore, in which the heat exchanger is a water charge air cooler comprising a tube or a channel formed by a pair of plates, having an external side where the gas to be cooled flows, said tube or plates being made from the brazing sheet according to the present invention with the interlayer located on said external side, and comprising fins made of an aluminium alloy having a Zn content from 1.25 to 3.00 wt. % fixed on said external side, and in which the Zn content of the interlayer is less than 120%, preferably less than 100% of the Zn content of the fins.

### BRIEF DESCRIPTION OF THE DRAWINGS

FIG. 1 shows a schematic longitudinal section of a tube (roll formed and brazed or welded tube) of an air cooled charge air cooler (air CAC).

FIG. 2 shows a schematic longitudinal section of a tube (channel formed by a pair of plates) of a water cooled charge air cooler (water CAC).

FIG. 3 shows a schematic three layer brazing sheet architecture.

FIG. 4 shows a schematic four layer brazing sheet architecture.

FIG. 5 shows: (a) state-of-the-art long life material before “CAC test”: specimen's back & edges protected with adhesive & silicone to avoid parasite corrosion. (b) state-of-the-art long life material after 2 weeks “CAC test” & hot water rinsing.

FIG. 6 shows a schematic representation of the cross section cutting process on a SWAAT sample (after removal of the silicone joint protecting the sample edges).

### DETAILED DESCRIPTION OF THE INVENTION

### Core Layer

The core layer is made of a 3xxx alloy.

Preferably, the core layer comprises, more preferably consists essentially of, in weight percentages:
up to 0.70%, preferably 0.05 to 0.35%, more preferably 0.10 to 0.30% Si,
up to 0.70%, preferably up to 0.40%, more preferably up to 0.25% Fe,
0.20 to 1.10%, preferably 0.30 to 1.00%, more preferably 0.35 to 0.60% Cu,
0.70 to 1.80%, preferably 1.10 to 1.60%, more preferably 1.20 to 1.50% Mn,
up to 0.40%, preferably up to 0.30%, more preferably up to 0.15%, even more preferably up to 0.10% Mg,
up to 0.30%, preferably up to 0.20% Zn,
up to 0.30%, preferably up to 0.20%, more preferably 0.01 to 0.20%, even more preferably 0.02 to 0.15% Ti,
Zr and/or Cr and/or V each up to 0.30%, preferably 0.01 to 0.30%, more preferably 0.02 to 0.25%,
other elements less than 0.05% each and less than 0.15% in total,
balance being aluminium.

Preferably, the core layer of the brazing sheet according to the present invention comprises 0.40 to 0.54 wt. %, more preferably 0.45 to 0.51 wt. % Cu.

Three core layer alloys suitable according to the present invention are described in Table 1 hereinafter, in wt. %:

TABLE 1
Core layer alloys suitable according to the present invention

| | Core-a | Core-b | Core-c |
|---|---|---|---|
| Si | 0.10-0.30 | 0.10-0.30 | 0.10-0.30 |
| Fe | ≤0.30 | ≤0.30 | ≤0.30 |
| Cu | 0.60-0.90 | 0.50-0.80 | 0.35-0.60 |
| Mn | 1.20-1.50 | 1.20-1.50 | 1.20-1.50 |
| Mg | 0.05-0.30 | ≤0.10 | ≤0.10 |
| Cr | ≤0.15 | ≤0.15 | 0.02-0.25 |
| Zn | ≤0.20 | ≤0.20 | ≤0.20 |
| Ti | 0.02-0.20 | 0.02-0.20 | 0.02-0.15 |

According to an embodiment, a core layer alloy suitable according to the present invention consists of, in weight %: 0.05 to 0.35% Si; up to 0.40% Fe; 0.25 to 0.70% Cu; 1.10 to 1.60% Mn; up to 0.15% Mg; 0.01 to 0.30% Cr; up to 0.30% Zn; 0.01 to 0.20% Ti; other elements less than 0.05% each and less than 0.15% in total, balance being aluminium.

The temper of the core layer may be a recovered structure such as H24 which is partially annealed or O-temper which is fully annealed. As is commonly known by the person skilled in the art, the tempers are defined for example in standard BS EN 515.

### Brazing Layer

Preferably, the Si content of the brazing layer is 5 to 13 wt. %.

Preferably, the composition of the brazing layer is AA4045 or AA4343.

For example, the composition AA4045 is, in wt. %: 9 to 11% Si, up to 0.8% Fe, up to 0.30% Cu, up to 0.05% Mn, up to 0.05% Mg, up to 0.10% Zn, up to 0.20% Ti, other elements less than 0.05% each and less than 0.15% in total, balance being aluminium.

For example, the composition AA4343 is, in wt. %: 6.8 to 8.2% Si, up to 0.8% Fe, up to 0.25% Cu, up to 0.10% Mn, up to 0.05% Mg, other elements less than 0.05% each and less than 0.15% in total, balance being aluminium.

According to an embodiment, the temper of the core layer is H24 and the brazing layer is present on only one side of the core layer, preferably on the interlayer side.

Preferably, the brazing layer is present on both sides of the core layer, on the interlayer when present, otherwise directly on the core layer, both brazing layers having the same or a different composition.

### Interlayer

The interlayer according to the present invention comprises, preferably consists essentially of, more preferably consists of, in weight percentages: from 1.5 to 2.3% Zn, from 0.2% (preferably 0.3%) to 0.75% (preferably 0.45%) Mn, up to 0.5% (preferably 0.4%) Fe, up to 0.5% (preferably 0.4%) Si, other elements less than 0.05% each and less than 0.15% in total, balance being aluminium.

Preferably, the Mn content of the interlayer of the brazing sheet according to the present invention is 0.3 to 0.4 wt. %. The effect of this specific range of Mn in the interlayer is illustrated by the examples hereinafter.

Preferably, the Zn content of the interlayer of the brazing sheet according to the present invention is 1.5 to 2.3 wt. %. The effect of this specific range of Zn in the interlayer is illustrated by the examples hereinafter.

Preferably, the Zn/Mn ratio in the interlayer is from 2 to 11, more preferably from 3 to 7.

Ti may increase the corrosion potential and thus render the interlayer less sacrificial compared to the core layer. Consequently, the content of Ti in the interlayer is preferably less than 0.05 wt. %.

Preferably, the thickness of the interlayer is up to 65 μm, more preferably up to 55 μm.

According to an embodiment, the brazing sheet according to the present invention is used in a water charged air cooler, as is for example illustrated by FIG. 2. In this specific embodiment, the interlayer is on the external side of the tube or pair of plates and fins are fixed on said external side. In this case, the external side of the tube or pair of plates is the side in contact with the gas to be cooled. In this embodiment, the Zn content of the interlayer is preferably less than the Zn content of the fins. This specific embodiment will be further described hereinafter.

### Sheet

Preferably, the brazing sheet according to the present invention is characterized in that the brazing layers and the interlayers have each a thickness of 3 to 30%, preferably of 5 to 15%, more preferably 8 to 12% of the total thickness of the brazing sheet.

The invention consists in a judicious choice of the respective alloys of the core layer, the interlayer and the brazing layer for carrying out a brazing sheet of the multilayer type, adapted to the severe corrosion conditions to which these materials are subjected in use, in particular in charge air coolers or air conditioning evaporators.

In particular, the concentration ranges imposed on the constituent elements of the alloy of the interlayer are explained by the following reasons:
Si has an unfavorable effect on the resistance to pitting and/or intergranular corrosion. Therefore, its content must be less than 0.5 wt. % and preferably less than 0.4 wt. %;
Fe is generally considered as an impurity for aluminium and constitutes privileged sites for the initiation of corrosion pitting. Therefore, its content must be less than 0.5 wt. % and more preferably less than 0.4 wt. %;
Cu also increases the corrosion potential thereby reducing the sacrificial anode effect of the interlayer. By its non-homogeneous distribution within the alloy, it may also increase the risks of galvanic corrosion and may favor intergranular corrosion by the presence of Al₂Cu-type phases, in particular at grain boundaries. Consequently, its content must be limited to that of an impurity, ie less than 0.05 wt. %;
Mn is a hardening element that has a positive effect on the strength after brazing by hardening in solid solution and in the form of fine dispersoids. Most importantly, it improves the hot flow stress of the alloy, greatly facilitating the co-rolling. But when there is too much Mn, the corrosion resistance is decreased in that the corrosion attack is not lateralized and not maintained in the interlayer level, and the core layer may be attacked by corrosion. Moreover, with too much Mn, the interlayer becomes less sacrificial compared to the core layer;
Mg has a positive effect on mechanical strength, but it is detrimental to brazability, since it migrates to the surface of the brazing layer and, especially in the case of controlled atmosphere brazing (CAB) of the “Nocolok®” type, forming an oxide layer which modifies in an unfavorable way the properties of the brazing. For this reason, and for such difficult applications, its content may be limited to 0.02% or even 0.01%;
Zn has an influence on corrosion resistance. Its content has to be balanced with the content of Mn. If there is too much Zn, the corrosion potential of the interlayer may be too low. In this case, the interlayer may deteriorate too fast, and in particular when the interlayer is located at fins side it could corrode faster than the fins (which are supposed to be protective). The content of Zn in the interlayer is thus preferably from 1.5 to 2.3 wt. %.

The presence of an interlayer allows to create a decreasing copper profile from the core layer to the brazing layer. This effect reinforces the effect of zinc on corrosion resistance.

The core layer side opposite to the interlayer side may be cladded directly with a brazing layer made of an alloy of the AA4xxx series. The brazing layers may have the same or a different composition.

However, an advantageous variant of this configuration is a symmetrical multi-layered composite material, that is to say provided with an interlayer on both sides of the core layer, one ensuring resistance to internal corrosion and the other to external corrosion, as is particularly favorable in the case of CAC type heat exchangers. In this embodiment also the brazing layers may have the same or a different composition. This is also the case for both interlayers.

### Process

The brazing sheet according to the present invention may be produced using any known process. The process may generally comprise the following successive steps:
casting the different alloys to obtain blocks;
scalping the blocks on both sides;
optionally homogenizing the interlayer;
preheating the brazing alloy and the interlayer alloy blocks at 400 to 550° C.;
hot rolling the brazing alloy and the interlayer alloy blocks until the desired clad thickness to get the desired cladding ratio;
optionally homogenizing the core layer alloy block at 550 to 630° C. during at least 1 hour, preferably 1 to 20 hours;
assembling the blocks to obtain a sandwich;
preheating the sandwich at 400 to 550° C.;
hot rolling the sandwich until an intermediate thickness, for example 2 to 4.5 mm;
cold rolling the hot-rolled sandwich until the desired final thickness, for example 0.15 to 1.20 mm, to obtain the brazing sheet;
annealing at 250 to 450° C. for at least 30 minutes.

The goal of the annealing step is to achieve the desired temper, for example H24 or O-temper.

Then the brazing sheet may be brazed to other sheets, that could have the same or another configuration. Preferably, the brazing process uses a flux, for example the known process called Nocolok®.

Such brazing sheets are particularly suitable for the manufacture of heat exchangers, preferably charge air coolers (CAC), exhaust gas recirculation (EGR) coolers, evaporators, condensers or radiators, more preferably charge air coolers (CAC), due in particular to a good behavior in stamping, and also a corrosion behavior significantly improved, as described in the examples below.

The invention consists of the best compromise between rolling ability and corrosion resistance. It differs from the known prior art at least by a specific selection of the amounts of Mn and Zn in the interlayer.

### Use

The brazing sheet according to the present invention may be used in the production of a heat exchanger of a motor vehicle, preferably a charge air cooler (CAC), an exhaust gas recirculation (EGR) cooler, an evaporator, a condenser or a radiator, more preferably a charge air cooler (CAC). As is known, there are two main kinds of CAC: air CAC and water CAC.

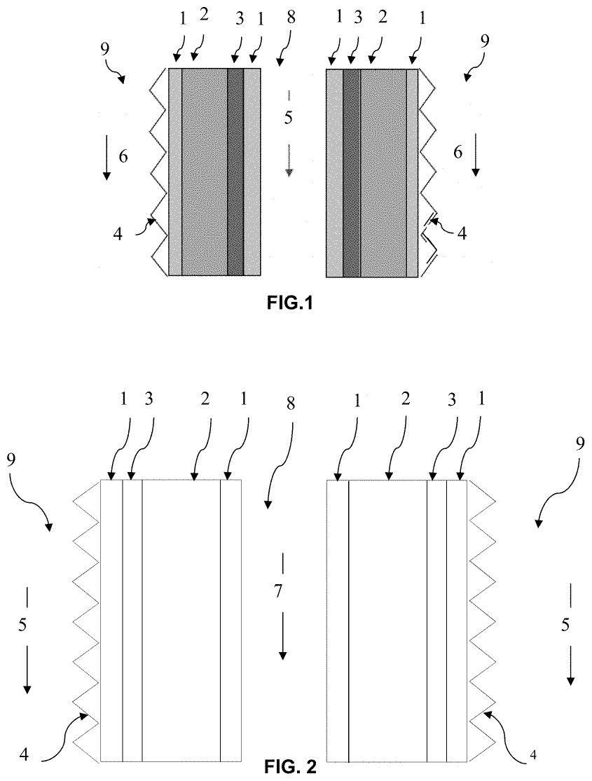

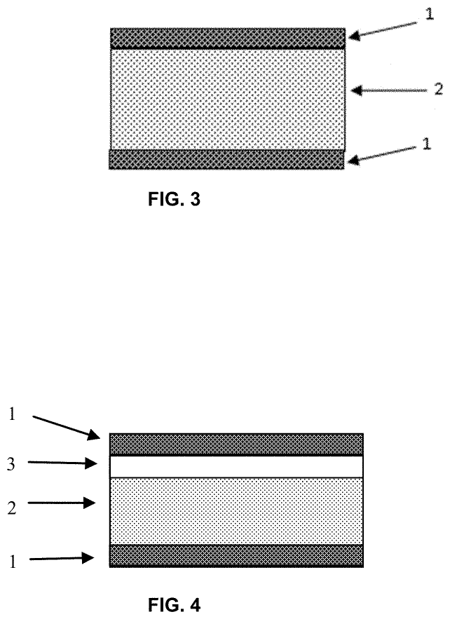

Air CAC may be illustrated by FIG. 1. FIG. 1 shows a schematic longitudinal section of a tube of an air cooled charge air cooler (air CAC).

The tube of air CAC as illustrated in FIG. 1 is made of a four layer brazing sheet. The brazing sheet comprises two brazing layers 1, which may have the same or a different composition, a core layer 2 and an interlayer 3. The reference number 4 represents the fins. It is understood that, according to another embodiment, the brazing sheet may comprise a second interlayer, on the opposite side with the same or a different composition compared to the first interlayer.

The gas to be cooled 5 flows through the internal side 8 of a tube (=the interlayer side). The air 6 flows at the external side 9 of the tube (=the interlayer opposite side). Fins 4 are positioned on the external side 9 of the tube. The interlayer 3 is positioned on the internal side 8 of the tube, where the gas to be cooled 5 flows.

Water CAC may be illustrated by FIG. 2. FIG. 2 shows a schematic longitudinal section of a tube (or channel formed by a pair of plates) of a water cooled charge air cooler (water CAC).

The tube (or channel formed by a pair of plates) of water CAC as illustrated in FIG. 2 is made of a four-layer brazing sheet. The brazing sheet comprises two brazing layers 1, which may have the same or a different composition, a core layer 2 and an interlayer 3. The reference number 4 represents the fins. It is understood that, according to another embodiment, the brazing sheet may comprise a second interlayer on the opposite side, with the same or a different composition compared to the first interlayer.

The coolant 7 flows through the internal side 8 of a tube or a channel formed by a pair of plates (=the interlayer opposite side). The gas to be cooled 5 flows at the external side 9 of the tube or channel formed by a pair of plates (=the interlayer side). Fins 4 are on the external side 9 of the tube or channel formed by a pair of plates. The interlayer 3 is positioned on the external side 9 of the tube or channel formed by a pair of plates, where the gas to be cooled 5 flows.

According to an embodiment, the brazing sheet according to the present invention may be used for the production of a heat exchanger of a motor vehicle, preferably a charge air cooler (CAC), an exhaust gas recirculation (EGR) cooler, an evaporator, a condenser or a radiator, preferably a charge air cooler (CAC).

According to another embodiment, the brazing sheet according to the present invention may be used for the production of a heat exchanger, in which the heat exchanger is a water charge air cooler comprising a tube or a channel formed by a pair of plates, having an external side where the gas to be cooled flows, said tube or plates being made from the brazing sheet according to the present invention with the interlayer located on said external side, and comprising fins made of an aluminium alloy having a Zn content from 1.25 to 3.00 wt. % fixed on said external side, and in which the Zn content of the interlayer is less than 120%, preferably less than 100% of the Zn content of the fins.

Preferably, the fin alloy comprises, more preferably consists of, a 3003 alloy to which Zn is added so that the total content of Zn is from 1.25 to 3.00 wt. %. Generally, a 3003 alloy comprises, in weight percentages: up to 0.60% Si; up to 0.70% Fe; from 0.05 to 0.20% Cu; from 1.00 to 1.50% Mn; up to 0.10% Zn; other elements less than 0.05% each and less than 0.15% in total; balance being aluminium.

In its details, the invention will be better understood thanks to the examples described hereinafter, which are however not limiting.

All documents referred to herein are specifically incorporated herein by reference in their entireties.

As used herein and in the following claims, articles such as “the”, “a” and “an” can connote the singular or plural.

In the present description and in the following claims, to the extent a numerical value is enumerated, such value is intended to refer to the exact value and values close to that value that would amount to an unsubstantial change from the listed value.

### Examples

FIG. 4 and Table 2 summarize the configurations and compositions of the investigated materials (in weight percentages). Before brazing all solutions were in O-temper and at a thickness of 400 microns. The interlayer thickness was 40 μm.

According to FIG. 4, the brazing layer 1 was made of AA4343 and represented 7.5% of the total thickness, on both sides of the brazing sheet. The interlayer 3 represented 10% of the total thickness, and the core layer 2 represented 75% of the total thickness.

TABLE 2
Investigated materials

| | Core | Interlayer composition | | | | | | | |
|---|---|---|---|---|---|---|---|---|---|
| | alloy | Si | Fe | Cu | Mn | Cr | Ti | Zr | Zn |
| Example-1 | Core-1 | 0.204 | 0.153 | <0.005 | 0.385 | <0.0016 | <0.005 | — | 1.95 |
| Example-2 | Core-2 | 0.204 | 0.153 | <0.005 | 0.385 | <0.0016 | <0.005 | — | 1.95 |
| Example-3 | Core-1 | 0.1 | 0.19 | | 0.69 | | | | 1.9 |
| Ref.1-Mn | Core-1 | 0.105 | 0.208 | 0.007 | 0.358 | 0.001 | 0.019 | 0.001 | — |
| Ref.2-Mn | Core-1 | 0.104 | 0.158 | 0.002 | 0.709 | 0.001 | 0.020 | 0.002 | — |
| Ref.3-Mn | Core-1 | <0.05 | <0.1 | — | 1.75 | — | — | — | |
| Ref-Zn | Core-1 | 0.097 | 0.184 | | 0.7 | | | | 0.98 |

Several 4 layer sheets with different core layer alloys, and interlayer alloys were prototyped. AA4343 alloy was used as brazing layer on both sides for all the prototyped sheets. The sheets marked Example-1, Example-2 and Example-3 are according to the invention. The sheets marked Ref.1-Mn, Ref.2-Mn, Ref.3-Mn and

Ref-Zn are comparative examples.

The Core-1 alloy had the following composition, in wt. %:

Si: 0.18 Fe: 0.15 Cu: 0.65 Mn: 1.35 Ti: 0.08 other elements <0.05 each and <0.15 in total, balance being aluminium.

The Core-2 alloy had the following composition, in wt. %:

Si: 0.19 Fe: 0.13 Cu: 0.51 Mn: 1.33 Cr: 0.09 Zn: 0.02 Ti: 0.01 other elements <0.05 each and <0.15 in total, balance being aluminium.

The alloy AA4343 had the following composition, in wt. %:

Si: 7.2 Fe: 0.15 Cu: <0.1 Mn: <0.1 Ti: <0.05 other elements <0.05 each and <0.15 in total, balance being aluminium.

The process for the production of brazing sheets was as follows:
casting the different alloys to obtain blocks;
scalping the obtained blocks on both sides;
preheating the brazing alloy and the interlayer alloy blocks at 500° C.;
hot rolling the brazing alloy and the interlayer alloy blocks until the desired clad thickness to get the desired cladding ratio;
homogenizing the core layer alloy blocks at 620° C. during 8h;
assembling the blocks to obtain sandwiches;
preheating the sandwiches at 500° C.;
hot rolling the sandwiches until a 3.5 mm thickness;
cold rolling until a 0.4 mm thickness; and
annealing at 350° C. during 1h to obtain a O-temper.

The sheets were then submitted to a brazing cycle simulation comprising a rise in temperature at 40° C./min up to 550° C., and then at 20° C./min up to 600° C. This temperature was kept during 2 minutes. Cooling was then done in the oven at around −25° C./min.

The obtained materials were then submitted to corrosion test.

### Corrosion Test

As a first and rough evaluation of the durability of investigated materials in a corrosive environment, ASTM G85A3-SWAAT test is generally carried out in a climatic chamber. The procedure is based on the following cycle: 30 min spray+90 min soak. A 5% synthetic sea salt solution at pH3 is used as the condensate. Although SWAAT test is extensively used for testing heat exchangers, this procedure is related to atmospheric corrosion and concerns the durability of the external side of heat exchanger such as air conditioning evaporators.

Concerning the specific case of Charge Air Cooler (CAC), SWAAT test has very limited value. Therefore, a dedicated corrosion test was developed to simulate corrosion in CAC heat exchangers. Knowing that exhaust gases circulating inside CAC consist mainly of CO₂, H₂O, NOx and SO₂ (depending on the diesel-sulfur level), if condensate formation occurs, this generates strong acid (HNO₃, H₂SO₄) and less corrosive organic acids. Exhaust-gas condensate composition and dew point depend on fuel composition, combustion process, air ratio, load of the engine, exhaust-gas after treatment, engine start-up stage, etc. . . . . Furthermore, EGR (Exhaust Gas Recirculation) system will frequently be exposed to successive wet and dry environments depending on the engine speed and temperature. States in which fluid acidic concentrate can dwell and dry on the components are critical. From these assessment, a corrosion test, hereinafter called “CAC test”, based on a 3-step 4h cycle was set up (see schema hereunder). This corrosion test, aiming at assessing the corrosion resistance seen in-service includes a dry and wet cycle as well as a spraying phase using a synthetic condensate made of sulfuric acid and nitric acid (H₂SO₄+HNO₃) equi-molar solution. Tests were conducted at pH 2 and 1000 ppm Cl⁻ during 6 weeks.

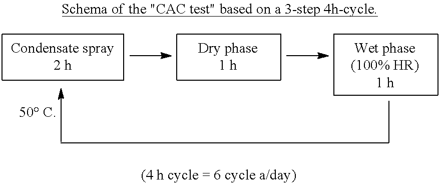

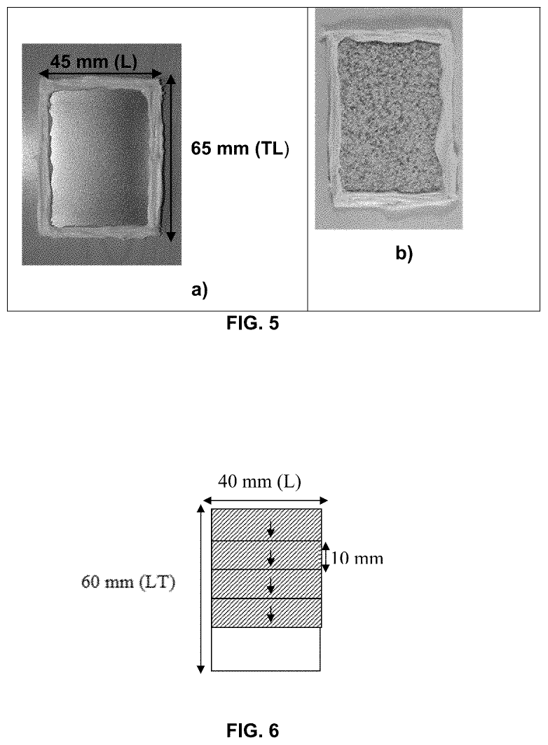

45 mm (L)×65 mm (TL)×0.48 mm (TC) samples were cut from each reference (see FIG. 5). The samples were degreased with acetone and then masked in order to expose only the front side to be tested. The edges and the back side respectively were protected with silicone and adhesive tape. Therefore, the tested surface was about 40 mm (L)×60 mm (TL) leading to an exposed surface of about 2400±100 mm².

When SWAAT test was completed, cross section micrographs in the L-ST plane were carried out to investigate corrosion morphology on the exposed side. Four 40 mm (L)×10 mm (TL) sections were cut as described in FIG. 6 and observed with optical microscopy using two different magnifications (i.e. ×50 and ×100) in order to obtain representative and reliable pictures of the attack mode.

The results of the optical microscopy observations are shown in Table 3 hereinafter.

TABLE 3
Results of the CAC corrosion test, after 6 weeks of exposure

| | Lateralization of corrosion | Absence of corrosion |
|---|---|---|
| | in the interlayer | of the core |
| Example-1 | + | ++ |
| Example-2 | ++ | ++ |
| Example-3 | + | ++ |
| Ref. 1-Mn | − | + |
| Ref. 2-Mn | − | + |
| Ref. 3-Mn | − | − |
| Ref-Zn | − | + |

In Table 3 hereinbefore, “−” means the absence of lateralization of corrosion in the interlayer or the presence of corrosion of the core layer in an important manner, “+” means the presence of lateralization or corrosion of the core layer in a moderate manner, and “++” means the presence of lateralization of corrosion in the interlayer in a fully effective manner or the absence of corrosion of the core layer. The results are based on micrograph observations.

The results presented in Table 3 hereinabove confirm the lateralization of the corrosion in the interlayer which plays its sacrificial role, at the same time as the absence of perforation of the underlying core layer for the compositions according to the present invention.

1. A brazing sheet comprising:
a core layer made of a AA3xxx alloy comprising, in weight percentages: up to 0.70% Si, up to 0.70% Fe, 0.20 to 1.10% Cu, 0.70 to 1.80% Mn, up to 0.40% Mg, up to 0.30% Zn, up to 0.30% Ti, Zr and/or Cr and/or V each up to 0.30%, other elements less than 0.05% each and less than 0.15% in total, balance being aluminum;
a brazing layer, made of a AA4xxx alloy, which is present on at least one side of the core layer; and
an interlayer, inserted between the core layer and the brazing layer, on at least one side of the core layer, which composition comprises, in weight percentages: from 1.5 to 2.3% Zn, from 0.2 to 0.75% Mn, up to 0.5% Fe, up to 0.5% Si, other elements less than 0.05% each and less than 0.15% in total, balance being aluminum.

2. The brazing sheet according to claim 1, wherein the core layer comprises 0.45 to 0.51 wt. % Cu.

3. The brazing sheet according to claim 1, wherein the core layer comprises, in weight %: 0.05 to 0.35% Si; up to 0.40% Fe; 0.25 to 0.70% Cu; 1.10 to 1.60% Mn; up to 0.15% Mg; 0.01 to 0.30% Cr; up to 0.30% Zn; 0.01 to 0.20% Ti; other elements less than 0.05% each and less than 0.15% in total, balance being aluminum.

4. The brazing sheet according to claim 1, wherein the brazing layer is present on both sides of the core layer, both brazing layers having the same or a different composition.

5. The razing sheet according to claim 1, wherein the Mn content of the interlayer is 0.30 to 0.40 wt. %.

6. The brazing sheet according to claim 1, wherein the brazing layer and the interlayer have each a thickness of 3 to 30%, optionally of 5 to 15% of the total thickness of the brazing sheet.

7. The brazing sheet according to claim 1, wherein the Zn/Mn ratio in the interlayer is from 2 to 11, optionally from 3 to 7.

8. The brazing sheet according to claim 1, wherein the thickness of the interlayer is up to 65 μm, optionally up to 55 μm.

9. A product comprising the brazing sheet according to claim 1 for production of a heat exchanger of a motor vehicle.

10. The product according to claim 9, in which the heat exchanger is a water charge air cooler comprising a tube or a channel formed by a pair of plates, having an external side where the gas to be cooled flows, said tube or plates being made from the brazing sheet with the interlayer located on said external side, and comprising fins made of an aluminum alloy having a Zn content from 1.25 to 3.00 wt. % fixed on said external side, and in which the Zn content of the interlayer is less than 120% of the Zn content of the fins.

11. A heat exchanger of a motor vehicle, produced at least partly from a brazing sheet according to claim 1.

12. The heat exchanger according to claim 11, in which the heat exchanger is a water charge air cooler comprising a tube or a channel formed by a pair of plates, having an external side where the gas to be cooled flows, said tube or plates being made from the brazing sheet with the interlayer located on said external side, and comprising fins made of an aluminum alloy having a Zn content from 1.25 to 3.00 wt. % fixed on said external side, and in which the Zn content of the interlayer is less than 120% of the Zn content of the fins.
